(19) United States
(12) Patent Application Publication
(10) Pub. No.: US 2014/0302958 A1
(43) Pub. Date: Oct. 9, 2014

(54) DRIVE DEVICE HAVING AN ELECTRICAL DRIVE MACHINE

(71) Applicant: SIEMENS AKTIENGESELLSCHAFT, MUENCHEN (DE)

(72) Inventors: Frank Baeuerlein, Postbauer-Heng (DE); Markus Kloepzig, Ebermannstadt (DE); Klaus Schleicher, Nuernberg (DE)

(21) Appl. No.: 14/354,014

(22) PCT Filed: Nov. 2, 2012
(86) PCT No.: PCT/EP2012/071709

§ 371 Date: Apr. 24, 2014

(30) Foreign Application Priority Data
Nov. 29, 2011 (DE) 102011087290.6

(51) Int. Cl. B60K 17/12

(52) U.S. Cl. CPC B60K 17/12
USPC 475/150

(57) ABSTRACT

A drive device is particularly suited for driving a vehicle. The device has an electrical drive machine with a rotor. The drive machine is coupled to a drive shaft by way of a gear arrangement. The gear arrangement, which includes a gear mechanism and/or a differential, is integrated within the rotor of the electrical drive machine.

The invention relates to a drive device, in particular for a vehicle, having an electrical drive machine, which is coupled to a drive axle by means of a gear arrangement.

The gear arrangement of the drive device serves to transmit the rotational speed of the electrical drive machine to a rotational speed of the drive axle. The gear arrangement usually comprises a gear mechanism and/or a differential to equalize different wheel speeds of a left and right wheel of the drive axle. A large installation space is required for traditional drive devices as the gear arrangement is connected thereto outside the drive machine. In particular, in the case of vehicles the drive device must be accommodated in the tightest installation space, for which reason there is a need for a space-optimized drive device.

The object of the present invention is to specify a drive device which can be provided with compact dimensions.

This object is achieved by a drive device according to the features of claim 1. Advantageous embodiments arise from the dependent claims.

The invention creates a drive device, in particular for a vehicle, having an electrical drive machine, which is coupled to a drive machine by means of a gear arrangement, wherein the gear arrangement, comprising a gear mechanism and/or a differential, is integrated within the rotor of the electrical drive machine.

Such a drive device can be provided with considerably smaller dimensions than a drive device for which the electrical drive machine and the gear arrangement are connected to each other as separate components. In particular, the axial extension of such a drive device can be reduced. As the housing of the gear arrangement can be omitted and additional components of the motor and gear mechanism can be used, a cost and weight saving is produced in terms of storage, cooling, lubrication and sealing.

When there is mention in the present description of the gear arrangement being integrated within the rotor into the electrical drive machine, this is taken to mean that the gear arrangement is arranged in the cavity between the rotor and the rotor shaft. The invention is based on the assumption that in a traditional drive machine the installation space between the rotor and the rotor shaft normally represents a dead space which is only filled with air and a support structure. The desired reduction of the drive device compared to separate components can be achieved by means of the arrangement of the gear arrangement in this dead space.

In particular, it is envisaged that a rotor shaft of the drive machine connected to the rotor in a rotatably fixed manner and an output shaft of the gear arrangement connected to the drive axle are arranged coaxially to each other. This produces a simple design structure with small dimensions of the drive device.

In an embodiment the gear arrangement comprises at least one planetary gear set. Such a planetary gear set can traditionally have a sun gear, a number of planetary gears which are borne by a planet carrier, and an annular gear. Such a planetary gear set can be provided both for the gear mechanism and for the optional differential.

In an expedient embodiment the gear arrangement comprises a first and a second planetary gear set, each with a sun gear and a number of planetary gears borne by a planet carrier, wherein the sun gear of the first planetary gear set is connected to the rotor shaft, and the sun gear of the second planetary gear set to the drive shaft, and the planetary gears of the first planetary gear set drive the planetary gears of the second planetary gear set. By omitting respective annular gears in the first and second planetary gear set a gear arrangement with a small diameter can be provided.

Furthermore, it permits the formation of a first and a second planetary gear set of a gear mechanism of the gear arrangement to set a desired transmission ratio between the rotor shaft and the output shaft. In particular, it is envisaged for this purpose that the planetary gears of the first planetary gear set have a different diameter and/or a different number of cogs from the planetary gears of the second planetary gear set. In particular, the planetary gears of the first planetary gear set have a larger diameter than the planetary gears of the second planetary gear set. By this means, a transmission ratio suitable for electrical drive devices in the motor vehicle can be set. This preferably ranges from a transmission of 1:5 to 1:15.

It is furthermore envisaged that the planet carrier of the gear arrangement is stationary. In addition, it is envisaged that the planet carrier carries the planetary gears of the first and the second planetary gear set.

In accordance with a further expedient embodiment, the rotor shaft and the output shaft are centered in relation to each other. Centering can take place e.g. by means of tailored coordination of all the housing tolerances.

Likewise, for centering it may be envisaged that centering takes place by means of a locating bearing which is arranged between the rotor shaft and the output shaft and couples the two shafts to each other. Alternatively, it may be envisaged that centering takes place via two bearing points of the planet carrier, wherein a first bearing point is coupled to the rotor shaft and a second bearing point is coupled to the output shaft.

Centering is also directly linked to the bearing arrangement of the two shafts, wherein this is essentially determined by the axial length of the drive device. For a first, short variant of the drive device, the rotor only needs to be connected to the rotor shaft via a single flange. For such a drive device, the rotor shaft and the output shaft may each be mounted on one side.

In a second, longer version of the drive device, provision may be made for the rotor to connect to the rotor shaft or the output shaft by means of a flange arranged at its opposite ends. This ensures better support for the rotor while both the end of the output shaft and the end of the rotor shaft should be mounted by means of a fixed bearing.

It is also expedient if the planet carrier is mounted on the rotor shaft and the output shaft by means of a fixed bearing and a floating bearing.

The invention is explained in more detail hereinafter with reference to exemplary embodiments in the diagram. The diagram shows:

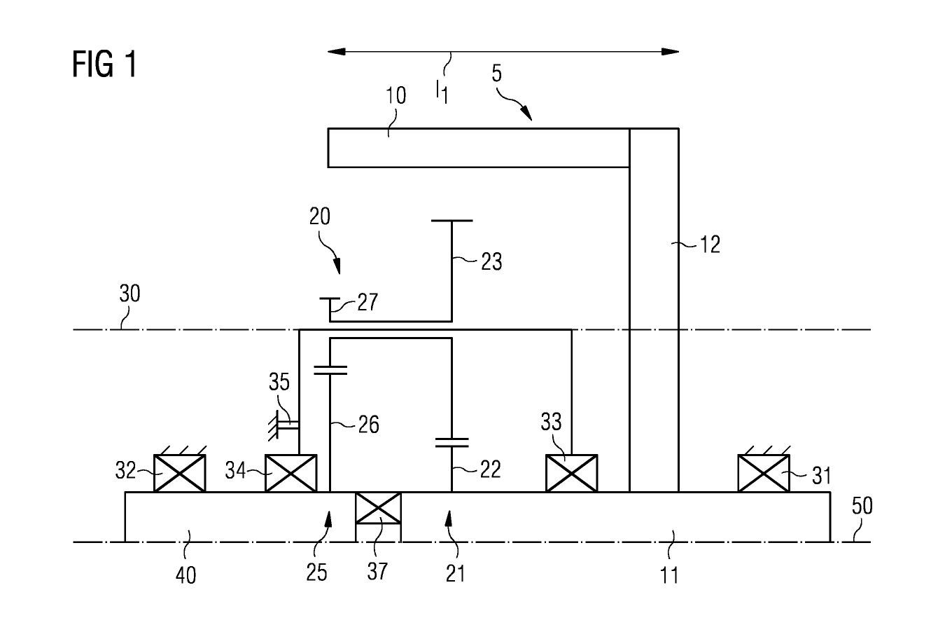

FIG. 1 a diagrammatic view of a drive device according to the invention according to a first embodiment variant, and

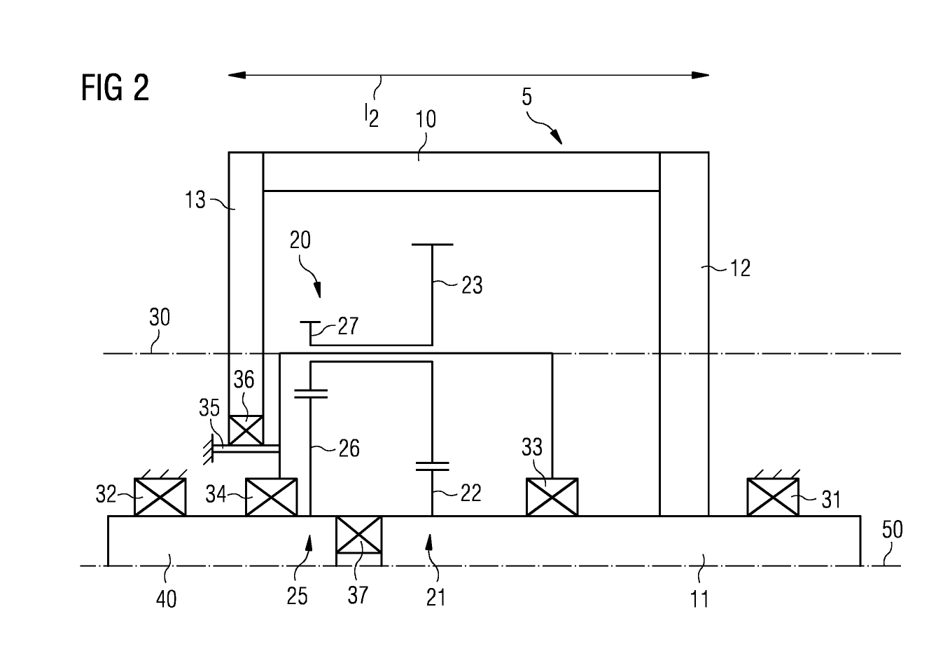

FIG. 2 a diagrammatic view of a drive arrangement according to the invention according to a second embodiment.

FIG. 1 shows a first exemplary embodiment of a drive device according to the invention. The drive device is envisaged in particular as a drive machine for a vehicle, such as e.g. a purely electrically driven or a combined electrical/internal combustion engine driven vehicle (hybrid vehicle). The drive device can naturally also be used in other applications, in particular when transmission of rotational speeds is required.

The drive device comprises an electrical drive machine 5 not shown in more detail. In the known manner, the electrical drive machine comprises a rotor 10 which for example is connected in a rotationally fixed manner by means of a rotor flange 12 to a rotor shaft 11. In each case only half of the drive machine 5 as well as of the other components of the drive device described in greater detail below are shown relative to an axis of rotation 50. A stator of the electrical drive machine 5, which is located above or outside the rotor 10 relative to the rotor shaft 11, is not shown explicitly. The structural design of the electrical drive machine corresponds to a traditional electrical drive machine which it is assumed is known to the person skilled in the art, dispensing with the need for a more detailed description at this point.

A gear arrangement 20 is arranged within the rotor, i.e. between the rotor 10 and the rotor shaft 11. The electrical drive machine 5 is coupled to a drive axle (not shown) of the vehicle by means of the gear arrangement 20. In the present exemplary embodiment the gear arrangement 20 only comprises a gear mechanism, by means of which the rotational speed ratio of the rotor shaft 11 and an output shaft 40 of the gear arrangement 20 connected to the gear mechanism is established. In principle, the gear arrangement may also comprise an additional differential.

The gear arrangement 20 in the exemplary embodiment of FIG. 1 is only shown in a diagrammatic view. The gear arrangement 20 comprises two planetary gear sets 21, 25. The planetary gear set 21 comprises a sun gear 22 which is connected in a rotationally fixed manner to the rotor shaft 11. The sun gear 22 meshes with a planetary gear set 23 (of which only one planetary gear is shown). The planetary gear set 23 is carried by a planet carrier (not shown), the planetary axis of which is characterized by the reference character 30. The planet carrier is preferably mounted in a stationary manner in the drive device.

The second planetary gear set 25 also comprises a sun gear 26 which is coupled in a rotationally fixed manner to the output shaft 40. The sun gear 26 meshes with a planetary gear set 27 which is also carried by the planet carrier of the planetary gear set 23. This results in the planetary gears 23 of the first planetary gear set 21 and the planetary gears 27 of the second planetary gear set 25 rotating around the respective planetary axis 30 at the same rotational speed. Only a single planetary gear 27 is illustrated for the second planetary gear set 25 as well.

The planetary gears 23, 27 are connected to each other in such a manner that the planetary gears 23 drive the planetary gears 27 of the second planetary gear set 25. Thus, a rotation of the rotor shaft by means of the gear arrangement 20 results in a rotation of the output shaft.

The planetary gears 23 of the first planetary gear set 21 and of the second planetary gear set 25 have a different diameter. The diameters of the planetary gears 23, 27 are in a ratio such that a desired rotational speed ratio of the rotor shaft and output shaft is reached. In the field of motor vehicles a transmission ratio of 1:5 to 1:15 could be selected. In principle, the transmission ratio must be selected according to the circumstances so that other transmission ratios could also be selected. It goes without saying that by varying the diameter ratio and/or the number of cogs, other rotational speed ratios can also be selected. The planetary gears 23, 27 of the first and second planetary gear set 21, 25 thus represent a graduated planetary gear arrangement.

In an embodiment variant not shown the gear arrangement could also comprise a traditional planetary gear set for which a sun gear, planetary gears and an annular gear are envisaged. The number of such planetary gear sets can be selected appropriately by a person skilled in the art.

The drive device in FIG. 1 is a so-called open version on account of the rotor flange 12 only being provided on one side of the rotor 10. Such a version is possible in particular when the length 1₁ of the rotor 10 plus the width of the rotor flange 12 does not exceed a certain length. Otherwise the mechanical stability would no longer be guaranteed. For such an open arrangement it is sufficient to mount both the rotor shaft 11 and the output shaft 40 only on one side. A corresponding bearing point for the rotor shaft 11 is characterized by the reference character 31, a bearing point for the output shaft 40 by the reference character 32. The planet carrier is stationary, e.g. connected to a part of the housing (reference character 35). In addition, it may be supported by means of bearing points 33, 34 on the rotor shaft 11 and the output shaft 40.

The rotor shaft 11 and output shaft 40 are centered in relation to each other. Centering can be achieved in different ways. On the one hand, tailored coordination of all the components of the drive device, in particular of the housing and the bearing points, is possible for both shafts. Centering can also be performed by mounting the planet carrier on the bearings 33, 34 or by means of a separate locating bearing 37. The locating bearing 37 permits the rotation of the rotor shaft and output shaft 40 independently of each other, but is able to align both the shafts flush with each other on account of its configuration.

FIG. 2 shows an alternative embodiment of a drive device according to the invention. For this drive device, in addition to the rotor flange 12, the rotor 10 is also fastened to a rotor flange 13 arranged at the opposite end. The rotor flange 13 is connected to the housing (cf. reference character 35) by means of a bearing point 36. This closed version, for which the gear arrangement 20 is more or less fully protected within the rotor 10 of the electrical drive machine 5, enables the rotor length to be extended compared with the variant according to FIG. 1. In FIG. 2 the length is 1₂, wherein 1₂>1₁. The length 1₂ comprises the length of the rotor 10 and the thicknesses of the rotor flanges 12 and 13.

The gear arrangement 20 corresponds to the gear arrangement described in connection with FIG. 1. However, on account of the possibly greater constructional length another kind of bearing is envisaged.

The rotor shaft 11 and output shaft 40 are connected to each other by means of a locating bearing 37. However, centering might also be performed in both the aforementioned ways (tolerances or use of the bearings of the planet carrier). Furthermore, this embodiment envisages mounting one of the two shafts 11, 40 by means of a fixed bearing and mounting the other of the two shafts by means of a floating bearing. In the exemplary embodiment the rotor shaft 11 is mounted by means of a fixed bearing 31. The output shaft 40 is mounted by means of a floating bearing 32. The planet carrier is mounted on the two shafts 11, 40 by means of a fixed bearing 33 and a floating bearing 34.

By means of the closed arrangement, i.e. the provision of rotor flanges 12, 13 on both sides and the type of mounting described, this arrangement can be used for long rotors, as a result of which the stability of the arrangement is improved.

In an additional embodiment variant (not shown) the gear arrangement could be of both single- and multi-stage design. In particular, it is not mandatory to use planetary gear sets without an annular gear. In the latter case, the aspect ratio of diameter to length of the drive device would change, a possibly smaller axial length being attainable with an increased diameter.

The drive device according to the invention has the advantage of a compact installation dimension, as the gear arrangement is integrated within the electrical drive machine. As the housing of the gear mechanism can be omitted and additional components of the motor and gear mechanism can be used, this results in a cost and weight saving.

1-14. (canceled)

15. A drive device, comprising:
an electrical drive machine having a rotor;
a drive shaft; and
a gear arrangement coupling said drive shaft to said electrical drive machine, said gear arrangement having a gear mechanism and/or a differential and being integrated within said rotor of said electrical drive machine.

16. The drive device according to claim 15, configured for driving a vehicle.

17. The drive device according to claim 15, wherein said drive shaft is a rotor shaft rotationally fixedly connected to said rotor of said drive machine, and said gear arrangement has an output shaft coupled to said drive shaft, and wherein said output shaft and said drive shaft are disposed coaxially with one another.

18. The drive device according to claim 15, wherein said gear arrangement comprises at least one planetary gear set.

19. The drive device according to claim 15, wherein:
said gear arrangement comprises a first planetary gear set and a second planetary gear set, each having a sun gear and a plurality of planetary gears carried by a planet carrier;
said sun gear of said first planetary gear set is connected to said rotor shaft;
said sun gear of said second planetary gear set is connected to said output shaft; and
said planetary gears of said first planetary gear set are configured to drive said planetary gears of said second planetary gear set.

20. The drive device according to claim 19, wherein said planetary gears of said first planetary gear set have one or both of a different diameter or a different number of cogs than said planetary gears of said second planetary gear set.

21. The drive device according to claim 19, wherein said planetary gears of said first planetary gear set have a larger diameter than said planetary gears of said second planetary gear set.

22. The drive device according to claim 19, wherein said planet carrier is a stationary carrier.

23. The drive device according to claim 19, wherein said planet carrier carries said planetary gears of said first and second planetary gear sets.

24. The drive device according to claim 17, wherein said rotor shaft and said output shaft are centered in relation to each other.

25. The drive device according to claim 24, which comprises locating bearings disposed between and configured to center said rotor shaft and said output shaft relative to one another, said bearings coupling said rotor shaft and the output shaft to each other.

26. The drive device according to claim 24, wherein said planet carrier has two bearing points effecting said centering of said rotor shaft and said output shaft, and wherein a first said bearing point is coupled to said rotor shaft and a second said bearing point is coupled to said output shaft.

27. The drive device according to claim 16, wherein said rotor shaft and said output shaft are each mounted on one side.

28. The drive device according to claim 16, wherein said rotor shaft and said output shaft have ends are mounted by way of a fixed bearing.

29. The drive device according to claim 16, which comprises a planet carrier mounted on said rotor shaft, and a fixed bearing and a floating bearing mounting an output shaft of said gear arrangement.
